(19) United States
(12) Patent Application Publication
(10) Pub. No.: US 2013/0180420 A1
(43) Pub. Date: Jul. 18, 2013

(54) METHOD AND SYSTEM FOR CONTROL OF FOUNTAIN SOLUTION OF A PRINTING PRESS

(71) Applicants: John RIVIERE, Lachine (CA); Denis BRUNELLE, Pointe-Claire (CA)

(72) Inventors: John RIVIERE, Lachine (CA); Denis BRUNELLE, Pointe-Claire (CA)

(73) Assignee: METAFIX INC., Lachine (CA)

(21) Appl. No.: 13/548,724

(22) Filed: Jul. 13, 2012

Related U.S. Application Data
(60) Provisional application No. 61/507,804, filed on Jul. 14, 2011.

(51) Int. Cl. B41F 7/32

(52) U.S. Cl. CPC B41F 7/32
USPC 101/148; 101/483

(57) ABSTRACT

The present describes a method and system for controlling conductivity of fountain solution during printing.

### FIELD OF THE INVENTION

This invention relates to a method and a system of controlling fountain solution in a printing press, and in particular controlling the conductivity of the fountain solution.

### BACKGROUND

There are many types of printing presses, described herein, is a method and system primarily concerned with improving offset or lithographic printing.

Fountain solution is an aqueous solution used in the lithographic printing processes. The fountain solution wets areas of the plate without an image. This wetting helps to ensure that in these areas no ink is deposited on the plate.

The repulsion of ink on areas of the plate without the image derives from the physical characteristics of the solution. Fountain solutions have been acid-based and often included other components selected from the arabic gum, chromates and/or phosphates, and magnesium nitrate. Other additives of the fountain solution include but are not limited to alcohol, (such as, ethanol) used as a wetting agent but because it also cools the printing press components, and facilitates the setting and drying of the printing ink.

Fountain solution is delivered as a concentrated solution and diluted with water. Fountain solution is regularly filtered but is often discarded when printing quality diminishes or after a given period of time has elapsed.

Furthermore, although the conductivity of the fountain solution in a printing press has been monitored in the past there has not been any attempt to control the fountain solution conductivity during printing. There are several reasons for this firstly the fountain solution is prepared frequently leading to generally fresh and good quality solution. Unused portions of fountain solution are discarded. Furthermore, conductivity probes in the past would often become inoperative due to ink and fibers and other contaminants from printing process.

The present invention provides a method and a system that can control the conductivity of the fountain solution of a printing press during operation that overcome deficiencies of the prior art and improve printing quality. Furthermore the invention permits the reuse of unused fountain solution without any negative effect on printing quality, while reducing or eliminating fountain solution disposal and the associated costs.

### SUMMARY OF THE INVENTION

In accordance with one aspect of the present invention, there is provided a method for controlling conductivity of a fountain solution in a printing press comprising the steps of: measuring a value of conductivity of the fountain solution of the printing press; comparing the measured value of conductivity to a set point and if the measured value is different from the set point adjusting the value of the conductivity by adding to the fountain solution of the printing press either a lean fountain solution comprising a lower conductivity value than the set point or a rich fountain solution comprising a higher conductivity value than the set point.

In accordance with another aspect of the method described above, the measured conductivity value is taken in a manifold within a fountain solution recirculation loop with the printing press, or from a dampening system tank of the printing press.

In accordance with yet another aspect the method described above, the lean fountain solution and/or the rich fountain solution are prepared by mixing water with a concentrated fountain solution.

In accordance with another aspect the method described above, the lean and the rich fountain solution are mixed before entry into the fountain solution recirculation loop.

In accordance with still another aspect the method described above, the pH of the fountain solution is monitored in the manifold, or from the dampening system tank of the printing press.

In accordance with another aspect of the invention, there is provided a system for regulating conductivity of fountain solution in a printing press comprising: a measurement device for measuring conductivity of the fountain solution of the printing press; and a control module operatively connected to the measuring device, receiving the conductivity measurement and adjusting the conductivity of the fountain solution of the printing press as a function of the conductivity measurement.

In accordance with another aspect of the system described above, the measurement device is a toroidal conductivity meter.

In accordance with yet another aspect of the system described above, further comprising a concentrated fountain solution pump and water control valve, wherein the control module adjusts the conductivity of the fountain solution by controlling the concentrated fountain solution pump and the water control valve.

In accordance with another aspect of the system described above, further comprising a flow meter for water hydraulically connected to the water control valve.

In accordance with another aspect of the system described above, the control module is operatively connected to a internet date base.

### BRIEF DESCRIPTION OF THE DRAWING

FIG. 1 is a flowsheet of a system for controlling the conductivity of fountain solution of a printing press according to one embodiment of the present invention.

### DESCRIPTION OF THE INVENTION

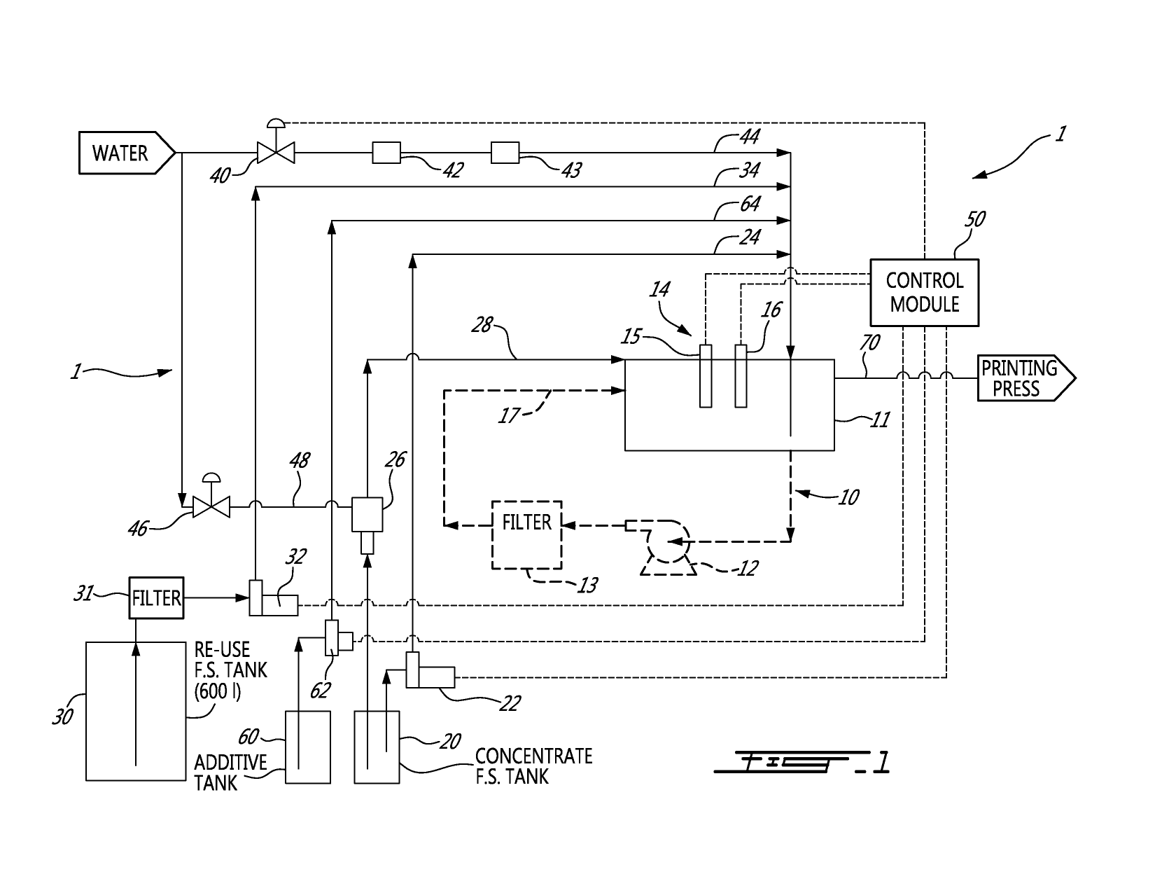

FIG. 1 schematically illustrates a control system 1 regulating the conductivity of a fountain solution in a printing press according to one embodiment of the present invention.

The printing press (not illustrated) includes a printing press dampening main tank 11 from where the fountain solution is recirculated to the printing press as indicated by stream 70, and optionally to a recirculation loop 10 for fountain solution conductivity control. The fountain solution may be recirculated in a recirculation loop 10 (illustrated by a heavy dashed line) that includes at least: a fountain solution recirculation pump 12, an optional filter 13 and a manifold 14 (generally located at line 17), all of which are in liquid communication with the printing press dampening system main tank 11.

If the recirculation loop 10 is present the fountain solution (FS) is withdrawn from tank 11 by the recirculation pump 12. The pump 12 may be of any type but is generally a centrifugal pump having a flowrate in the order of 15 liter/m. Pump 12 has a flowrate and pressure adapted to recirculate the fountain solution through the recirculation loop 10. If the filter 13 is present it may be any type but in a preferred embodiment includes two cartridge filters in series. The first filter trapping 50 μm particles while a second filter trapping 5 μm particles. The recirculation pump may include an amp meter that gives an indication of the state cleanliness of the filters. After the fountain solution has been filtered, it may enter a pipe manifold (not illustrated), or the system dampening tank 11, either of which include a C-P-T manifold 14 having a means to measure: conductivity (C); pH (P), and temperature (T). The C-P-T manifold 14 comprises a pH meter 15 and a conductivity meter 16 (an if in tank 11, level switches, not illustrated). The conductivity meter 16 may include temperature measurement. In a preferred embodiment, the conductivity meter 16 is a toroidal conductivity meter. From the C-P-T manifold 14, the fountain solution is controlled through connections (illustrated by lighter dashed lines) to a control module 50.

In another embodiment illustrated in FIG. 1, the conductivity pH, and temperature measurement may be taken from the dampening system main tank 11 in of the printing press. The toroidal conductivity meter has the advantage that it does not become inoperable due to the composition of the fountain solution or due to contaminants in the fountain solution, because the toroidal conductivity meter needs much less cleaning and calibration because it is a substantially closed probe. Toroidal probes have the further advantage that they are immune to ground loop interference.

In one embodiment of the present control system 1 further includes: a fountain solution concentrate tank 20; FS concentrate pump 22; a water control valve 40, a hydraulically connected water flow meter 42; a re-use FS tank 30; a re-use FS pump 32, and a control module 50 controlling of these components.

Fresh fountain solution FS is generally produced from the concentrate tank 20 and line 24 with the addition of water from line 44. Normal or standard concentrations of FS vary. However, a concentration of 2 to 10 ounces concentrated FS/USG water, and preferably 4 ounces of concentrated FS/US gallon water are common for fountain solution. This is equivalent to 1 to 5 ml. concentrated FS/250 ml water, or preferably 8 ml. concentrated FS/250 ml water.

The unit of conductivity of the fountain solution is generally in terms of Siemens/meter or S/m measured at 25° C. (standard temperature). A traditional unit of conductivity in solution is μS/cm. However, solution conductivity in the past has been measured by mhos//m, where a mho is the reciprical of an ohm. In a preferred embodiment the range of the conductivity of the fountain solution is 500 to 3500 μS/cm.

The FS concentrate pump 22 in a preferred embodiment is a fixed speed pump, and dilution ratios are varied by (a time) control of the solenoid valve 40 and pump on-time. In another embodiment FS concentrate pump 22 is a metering pump that has a variable flow capacity of 0 to 500 ml/min. This variation of flow permits a wide range of dilutions of FS to be prepared. The water control valve 40 is generally a solenoid valve that adds water at range of flowrate generally from 10 to 100 l/min, and more preferably between 5 and 20 l/min. Many variation of the mixing system are possible and would be known to the skilled practitioner. In one embodiment the solenoid valve 40 is an on/off valve. This mixing system of water and concentrated fountain solution is also adapted to make a rich fountain solution with a higher (concentration and) conductivity then the normal fountain solution as well as a lean fountain solution that has a lower (concentration and) conductivity than the normal or standard FS. The rich FS is generally 5 to 50% more concentrated than a standard solution while a lean FS solution is roughly 5 to 50% less concentrated than a normal solution. The higher percentages of FS solution are used when a faster response is required, for example, when the target FS conductivity set point must be changed.

In a preferred embodiment, the concentrated fountain solution tank 20 also includes a connection to a mechanical proportioner 26 (piston or pump) linked to the water flow control valve meter 46 adding water 48 to the proportioner, and mixing concentrated fountain solution to the tank 11 via line 28. This system is a failsafe in case the control system of tank 11 malfunctions.

Normal or re-used fountain solution may also be added from re-use FS tank 30. Re-use FS pump 32 is generally a metering pump with a flowrate in the order of 0 to 500 ml/min. In a preferred embodiment, the re-use FS in a filter on the suction side of pump 32, to remove particulate matter.

The tanks 11, 20 and 30 includes level measurement (typically lower/high level switches) that send a level signal to the control module 50. The fountain solution in tank 11 is used during printing and must be made up from tank 20 and water valve 42 through pipes 24 and 44 respectively and/or from tank 30 and pipe 34. Pipes 24, 34 and 44 are generally connected to the recirculation loop 10 between the tank 11, and the manifold 14.

In a preferred embodiment, various additives may also be added from an additive tank 60. The additives are generally an alcohol, or mixture of alcohols, where the alcohol is isopropyl alcohol. Other printing additives may also be added via this system or parallel system. The additive system includes tank 60, metering pump 62, and line 64 connected to tank 11, and is also controlled through the control module 50.

Typical logic for the control module 50 includes a large number of functions. In one embodiment, at start up the level in tanks 11, 20, 30 and 60 are checked. If the level in tank 11 is low it is filled with freshly prepared fountain solution from either pipes 24 and 44 and/or 34. When the level in tank 11 is sufficiently high, the recirculation pump 12 may be started and a conductivity value is measured. The control module 50 will compare the measured conductivity value with the set point or target value of conductivity established by the printing press operator. If the conductivity of the measured value is different for the set point, that is, if it is more than 5% above or below the set point and preferably if it is more than 1% above or below the set point, an action must be taken to adjust the conductivity of the fountain solution. If the measured conductivity is below the set point, a rich fountain solution will be added to the tank 11. By contrast, if the measured conductivity is above the set point, a lean fountain solution is added to tank 11. If the conductivity measured is within the selected 5% or 1% range of precision of the set point then no action needs be taken, or re-used or normal fountain solution having the set point conductivity, can be added to make up for the fountain solution being taken away with the printing. In this way, the level in the printing press dampening tank 11 would remain relatively constant.

The control module may comprise C.P.T. boards at various points of the system 1. In a preferred embodiment, the system includes C.P.T. boards downstream of control valve 40, and in the system tank 11. During printing, the control system 50 from the various controllers/monitors and internal algorithms improve printing quality and FS usage. The control system 50 obtains a conductivity from probe 43 of the incoming water 44 and maintains the conductivity of the FS above that of the incoming water 44.

In a preferred embodiment, the control module 50 includes further functionalities that include: monitoring and quantifying all liquid levels in the tanks 11, 20, and 30 and; monitoring all flows from pipes 24, 34 and 44, concentrated FS, normal or reused FS and dilution water respectively. The pH of the solution is also monitored by the control module 50. The control module is operatively connected to an internet data base so that a printing press operator may follow the consumption of raw materials and generally printing parameters from the internet.

1. A method for controlling conductivity of a fountain solution in a printing press comprising the steps of:
measuring a value of conductivity of the fountain solution of the printing press;
comparing the measured value of conductivity to a set point and
if the measured conductivity value is different from the set point adjusting the value of the conductivity by adding to the fountain solution of the printing press either a lean fountain solution comprising a lower conductivity value than the set point or a rich fountain solution comprising a higher conductivity value than the set point.

2. The method according to claim 1, wherein measured conductivity value is taken in a manifold within a fountain solution recirculation loop with the printing press, or from a dampening system tank of the printing press.

3. The method according to claim 2, wherein the lean fountain solution and/or the rich fountain solution are prepared by mixing water with a concentrated fountain solution.

4. The method according to claim 3, wherein the lean and the rich fountain solution are mixed before entry into the fountain solution recirculation loop.

5. The method according to claim 4, wherein the pH of the fountain solution is monitored in the manifold, or from the dampening system tank of the printing press.

6. A system for regulating conductivity of fountain solution in a printing press comprising:
a measurement device for measuring conductivity of the fountain solution of the printing press; and
a control module operatively connected to the measuring device, receiving the conductivity measurement and adjusting the conductivity of the fountain solution in the printing press as a function of the conductivity measurement.

7. The system according to claim 6, wherein the measurement device is a toroidal conductivity meter.

8. The system according to claim 6, further comprising a concentrated fountain solution pump and water control valve.
wherein the control module adjusts the conductivity of the fountain solution by controlling the water control valve and the concentrated fountain solution pump.

9. The system according to claim 8, further comprising a flow meter for water hydraulically connected to the water control valve.

10. The system according to claim 6, wherein the control module is operatively connected to a internet date base.
